(19) United States
(12) Patent Application Publication
(10) Pub. No.: US 2025/0350869 A1
(43) Pub. Date: Nov. 13, 2025

(54) MID-FREQUENCY AND HIGH-FREQUENCY LOUDSPEAKER ASSEMBLY

(71) Applicant: ADAMSON SYSTEMS ENGINEERING INC., Port Perry (CA)

(72) Inventors: Brock ADAMSON, Port Perry (CA); Brian FRASER, Port Perry (CA)

(21) Appl. No.: 19/201,154

(22) Filed: May 7, 2025

Related U.S. Application Data
(60) Provisional application No. 63/643,825, filed on May 7, 2024.

(51) Int. Cl. H04R 1/02

(52) U.S. Cl. CPC H04R 1/026

(57) ABSTRACT

A loudspeaker assembly having a waveguide, comprising: a housing comprising an outer duct and a phase plug housing; a first driver comprising a diaphragm; a second driver coaxially disposed in front of the first driver diaphragm and comprising a capsule having a rear surface, wherein a curved passageway is formed around the capsule within a duct; and a phase plug disposed between the first driver diaphragm and the second driver, the phase plug positioned within the phase plug outer housing, and defining at least one slot having an inlet for providing air movement between the first driver diaphragm and the curved passageway; wherein the rear surface of the capsule forms part of the phase plug, and a uniform gap is defined between the first driver diaphragm and the rear surface of the capsule, and wherein the first driver is a lower frequency driver than the second driver.

### CROSS-REFERENCE TO RELATED APPLICATION

This application claims the priority benefit of U.S. Provisional Patent Application No. 63/643,825, filed on May 7, 2024, the entire contents of which are incorporated herein be reference.

### FIELD

This specification concerns the field of sound reproduction, and more specifically describes a loudspeaker system having a novel mid-frequency and high-frequency driver configuration.

### BACKGROUND

The extremely large range of wavelengths perceived by humans presents a great challenge in the engineering of loudspeakers designed to reproduce it. Human auditory perception spans a range of approximately eleven octaves or three decades, a far greater range than other human senses such as vision which only spans a narrow range of the electromagnetic spectrum. The lowest frequencies detectable by human hearing reach a wavelength of about 17 meters (about 20 Hz) whereas the highest detectable frequency wavelength is only about 1.7 cm long (about 20 kHz).

Commonly, loudspeakers are designed as a two-way system which combines a low frequency (LF) driver and a high frequency (HF) compression driver. The audio spectrum is divided electrically into high and low frequency bands with either a passive or active crossover, providing each of the LF and HF drivers with a suitable signal. However, the large bandwidth required by each driver presents a challenge in the design and function of the two-way system. For example, a LF speaker cone, which conventionally has a large mass, performing as a piston massive enough to reproduce 40-60 Hz cannot operate effectively as a piston at 800 Hz or greater. Equally, a HF diaphragm sturdy enough to reproduce 800 Hz will be too massive to reproduce 20 kHz. These two very dissimilar driver types result in a two-way system that finds natural bandwidth limits at the upper and lower frequency extremes of each driver type.

The summation of the acoustical output of the two dissimilar drivers provides a further design challenge in the two-way system. For example, if a crossover of 800 Hz is chosen, the upper frequency range of the LF driver is different in many ways to the lower frequency range of the HF driver and horn. These differences might include timbre, directional and transient characteristics, and perhaps in the smoothness of the pressure response.

Virtually all HF compression drivers are made to mount on standardized horns with a standard opening aperture. Circular exit dimensions for HF compression drivers almost invariably range from 0.75″ to 2″, even with novel or unique HF diaphragm geometries. Typically, radiated energy from a compression driver passes through a closely fitted phase plug and generally forms a circular isophase wavefront at an exit suitable for attachment to a horn or waveguide.

However, the resulting wavefronts are convex and diverging due to the small horn entrance and its relatively large exit. Furthermore, the diameter of the HF driver magnet is greater than the horn throat, which limits the proximity of the horn throats. An array of horns and drivers therefore, no matter how closely spaced, results in substantial destructive interference increasing in severity as frequency increases. One method of mitigating destructive interference is the use of wave shaping devices, which are mechanical interfaces between a speaker driver and the audience.

The three-way loudspeaker system emerged as a solution to the driver-bandwidth limitation of two-way systems, with the addition of a mid-range or mid-frequency (MF) driver. MF drivers are typically tasked with reproducing frequencies in the range of about 200 Hz to about 6 kHz. This reduces driver-bandwidth challenges but at the cost of adding another crossover region to contend with. In this configuration, each driver is afforded greater allowable specialization to its purpose since the operating bandwidth is reduced.

MF transducers developed for small systems suited for a limited number of listeners found in broadcast, recording and consumer applications are straightforward and technologically coherent. These MF drivers are commonly derived from either a reduced size LF cone driver or an increased size HF tweeter dome, each scaled in size to fit the bandwidth requirement.

MF drivers in large scale systems, by comparison, display varied configurations incorporating novel geometry. MF reproduction has not found a consensus driver and related geometry solution and in the line array element, and reproduction of the mid-frequency range remains an evolving field of innovation. It is possible to view mid-range driver solutions as either derived from LF driver or HF driver principles and methods, or some combination of both.

Certain existing MF driver embodiments reflect the technology and high efficiency of the horn loaded HF compression driver, scaled up in size to allow the reproduction of mid-band frequencies. Other embodiments might more closely resemble the lower efficiency direct radiator cone loudspeaker, scaled down in size; and yet other embodiments resemble a hybrid or synthesis of technologies from both driver types, even to the extent of co-axial mid/high solutions.

MF drivers derived from LF driver concepts generally suffer from poor efficiency and weak upper band response, because of limitations arising from diaphragm stiffness and mass and dynamic motor efficiency. A LF diaphragm scaled smaller to reduce mass, becomes an impedance mismatch at its low frequency limit, lacking acoustical resistance. When horn loading is added, it will perform well at the lower part of the decade, but the diaphragm will have too much mass and will lack stiffness to perform adequately in the upper part of the decade.

MF drivers derived from HF compression driver concepts have limited low frequency performance due to the fragility of HF diaphragm materials and the displacement limitations of a single suspension diaphragm in a typical compression driver magnetic assembly. Such MF drivers display unstable axial behaviour in moving coil assemblies, a phenomenon referred to as wobble. A magnetic motor structure conceptualized for high efficiency and limited axial movement, when disposed to reproduce mid-frequencies, may become dynamically unstable and exhibit non-axial and modal behaviour, resulting in distortion and possible destruction of the coil.

Mid range approximations and compromises have resulted in drivers and driver implementations that are conceptual hybrids that deliver reasonable performance but fail to deliver good results either at the upper or lower edges of the middle decade of sound. These may take the form of simple devices and innovations, marked by ease of manufacture. The most popular MF driver choice is the cone loudspeaker. The driver may be optimized for mid-range reproduction, with accessories added to the MF driver or features added to the line array element that attempt to mitigate destructive interference in the upper range of the MF driver. These solutions face further difficulties in acoustic summation through the MF/HF crossover region, where coherence of speech frequencies is important.

Ring radiators have shown excellent performance in smaller line array elements, but notably do not extend into the lower midrange, in some cases unable to operate below 500 Hz. In some cases, a four-way system is provided wherein small diameter cone MF drivers in the range of 5″ operate between the ring radiator and LF driver frequency ranges. The largest LF drivers in a three-way system utilizing a ring radiator is currently 12″, extending the LF frequency limit upwards to provide support for the MF driver. Accordingly, ring radiator MF drivers are not currently applied to larger line array elements.

One solution in mid-range reproduction was the M4 midrange driver. The M4 driver was designed as a compression driver, with a combined cone and dome diaphragm and a matching plastic phase plug, exceeding the thermal efficiency of existing HF compression drivers. The diaphragm was lightweight and stiff, formed as a sandwich assembly of two aluminum skins injected with polyurethane foam, but suffered somewhat from fragility at high power near the low frequency limit of the driver. The diaphragm and the exit of the phase plug were sufficient for full power output down to 200 Hz. The pathways in the phase plug were approximately perpendicular to the non-convex arbitrarily shaped diaphragm, approximately parallel to the axis of propagation, resulting in slightly unequal path lengths, thus limiting its HF performance.

The Adamson M200 midrange driver included a cone and dome shaped diaphragm coupled with a phase plug comprising equal length slots, which resulted in improved upper frequency performance and efficiency. The cone, formed from a Kevlar composite, mated to the solid aluminum phase plug, was virtually indestructible to the lowest frequency of operation. The equal path lengths from the cone and dome shape naturally result in an annular shaped summation of the wavefront. Further passageway modification resulted in the desired circular planar driver exit.

In both the M4 and M200 drivers, correctly coupling the driver to the throat of a horn with a properly conceived phase plug to a relatively larger but low mass mid-range loudspeaker diaphragm, following the example of the HF compression driver, provided an improved impedance match between the high mass low-compliance diaphragm and low mass high compliance air load, resulting in improved efficiency. The length and shape of the horn throat offers a means to improve performance at the lower edge of the bandwidth and the shape of the exit introduces a means of controlling the radiating pattern, or directivity of the wavefront.

Alternatively, embodiments resembling over-sized HF drivers have been introduced as midrange compression drivers. The same efficiencies as HF compression drivers have been achieved, but the result has been a bandwidth limitation at lower frequencies. These devices have not gained in popularity and are not widely used.

A co-axial mid-high driver solution, the Adamson Y-Axis system, described as co-entrant and co-linear at the exit, combined the MF compression driver with a phase plug utilizing the outside surface of an HF sound chamber as part of the MF phase plug to achieve a dual frequency range assembly. By placement of an HF sound chamber axially, a clearly defined annular shaped mid-range wavefront is formed. The annular wavefront is then divided into two crescent shaped wavefronts and further into two parallel rectangular wavefronts at the exit of the waveguide. The Y-Axis system proved successful despite being more complex and more costly to manufacture than other conventional MF solutions. Similar efforts to develop fully horn loaded midrange compression drivers for line array elements have not emerged.

Conventionally, a typical co-axial LF/HF driver arrangement places the HF driver on the back of the LF driver magnet, placing the HF driver axially aligned and behind the LF driver. When adapted to a line array element, the HF driver is placed further back in the array element than the MF driver, which limits the total pathlength from diaphragm to exit. Since the MF wavelengths are longer than the HF, this is the opposite of the desired relationship, which would have the MF driver at the rear of the structure.

Very large audiences require multiple closely spaced loudspeaker systems, referred to as an array, to be assembled and operated in parallel to achieve sufficient sound power. Additional interference patterns must be considered in the creation of an array. Typically, loudspeaker systems are placed in a single vertical row, known as a line array. Individual loudspeaker systems adapted to form part of such a loudspeaker array can be referred to as a line array element or a line source element. In turn, a line array element includes multiple line source devices, which are each individual sound chambers or wave shaping devices. A line array element is conventionally a single rectangular enclosure oriented horizontally wherein the HF drivers and their associated line source devices are placed centrally along a vertical plane. MF drivers and LF drivers may then be provided in different configurations, flanking this central vertical plane.

Line source devices have addressed HF interference through control of the curvature of the wavefront thus reducing or eliminating interference patterns and are now found in line array elements throughout the commercial audio field. Extensive structural innovation and added optimisation through Finite Element Analysis and Boundary Element Method have resulted in improved geometries with better general performance. This allows for the assembly of multiple acoustic sources with reduced interference. Other line source devices, such as a ribbon tweeter achieve this effect by having the inherent properties of a narrow rectangular exit aperture and a flat wavefront.

A novel configuration of a line array element (U.S. Pat. No. 9,344,800 to Adamson) that includes the Adamson Y-Axis innovations adapted for use in a line array, is a multi-driver arrangement having two enclosures (e.g. for LF drivers) which are laterally separated from one another and fixed in that position by a structure which may also be responsible for holding MF and/or HF drivers, associated acoustic source devices, and potentially additional equipment (e.g. electronic equipment). This solution works well in large line array systems, which provide the scale needed to house the mid-high loudspeaker assembly, however, the respective axial positions of the MF and HF drivers was not addressed in this arrangement.

### SUMMARY OF THE INVENTION

Embodiments described herein provide loudspeaker configurations which may provide sufficient acoustic pathlength through the passageways of the assembly as required for MF wavelengths, which are longer than HF wavelengths, by mitigating the axially limiting position of the MF and HF drivers.

Therefore, in one aspect, disclosed is a loudspeaker assembly having a waveguide, comprising:
(a) a housing comprising an outer duct and a phase plug housing;
(b) a first driver comprising a diaphragm;
(c) a second driver coaxially disposed in front of the first driver diaphragm and comprising a capsule having a rear surface, wherein a curved passageway is formed around the capsule within the outer duct; and
(d) a phase plug disposed between the first driver diaphragm and the second driver, the phase plug positioned within the phase plug outer housing, and defining at least one slot for providing air movement (acoustic coupling) between the first driver diaphragm and the curved passageway;
   wherein the rear surface of the capsule forms part of the phase plug, and a gap is defined between the first driver diaphragm and the rear surface of the capsule, and wherein the first driver is a lower frequency driver than the second driver.

In a preferred embodiment, the first driver is an MF driver and the second driver is a HF driver.

In a preferred embodiment, the capsule is semi-ovoid or semi-elliptical, and the rear surface comprises an inner curve matching the first driver diaphragm dome.

In some embodiments, a uniform gap is defined between the first driver diaphragm and a rear surface of the phase plug, which matches the uniform gap between the first driver diaphragm and the rear surface of the capsule.

In some embodiments, the phase plug comprises the rear surface of the capsule such that the at least one slot is formed between capsule and the phase plug housing.

In some embodiments, the phase plug comprises at least one ring disposed between the first driver diaphragm such that a first slot is formed between the at least one ring and the phase plug outer housing, and a second slot is formed between the at least one ring and the rear surface of the capsule. Preferably, the phase plug comprises first and second rings, wherein a first slot is formed is formed between first ring and the phase plug outer housing, a second slot is formed between the first and second rings, and a third slot is formed between the second ring and the rear surface of the capsule. In other embodiments, a plurality of x rings are disposed between the rear surface of the capsule and the first driver diaphragm, within the phase plug outer housing, such that x+1 slots are formed.

In some embodiments, where the first driver is an MF driver, the maximum distance from any one point on the MF diaphragm to a slot inlet does not exceed a value of about 5.7 cm, 4 cm, 3cm, or about 2.5 cm, which value is ¼ of the wavelength of the highest intended operating frequency of the MF driver.

In some embodiments, where there is more than one slot, each slot inlet is positioned equidistantly across the face of the phase plug, when viewed axisymmetrically.

### BRIEF DESCRIPTION OF THE FIGURES

The accompanying drawings, which are incorporated herein and form a part of the specification, illustrate some, but not the only or exclusive, examples of embodiments and/or features.

FIG. 1 is an orthogonal view of one embodiment of a loudspeaker assembly, comprising first and second drivers, a phase plug assembly, sound chambers and waveguides. FIG. 1A shows a 3-way loudspeaker system (line-array) having the assembly of FIG. 1 deployed within.

FIG. 2a is an exploded front view of a mid-high frequency phase plug assembly. FIG. 2b is an exploded rear view of the same assembly.

FIG. 3a is an exploded front view of mid-frequency phase plug assembly. FIG. 3b is an exploded rear view of the same assembly.

FIG. 4A is a x-z horizontal plane section view of the same assembly. FIG. 4B is a vertical y-z plane section view of the same assembly. FIG. 4C shows a x-z horizontal plane section view of an alternative embodiment. FIG. 4D shows a x-z horizontal plane section view of yet another alternative embodiment.

FIG. 5A is a x-z horizontal plane section view of the assembly comprising a MF driver, phase plug and waveguide, as well as the HF driver, sound chamber and waveguide. FIG. 5B is a y-z vertical plane section view of the same assembly. FIG. 5C is a x-z horizontal plane section view of FIG. 5A, with lines A-G. FIG. 5D is a series of x-y vertical plane section views, along lines A-G in FIG. 5C, of the air passageway of the annular portion of the mid phase plug, through the transition portion, terminating at the mouth of the waveguide.

FIG. 6 is an isometric view of the assembled assembly of FIGS. 2a, 2b, 3a and 3b.

FIG. 7a shows schematic depictions of concave and convex diaphragms, displaying perpendicular rays from points along the diaphragm surface. FIG. 7B shows a cross-section of one embodiment of the MF diaphragm and phase plug assembly and a schematic of the pathlengths representing the first, second and third slots which guide MF acoustic waves to the curved passageway.

FIG. 8 is a depiction of an alternative embodiment of an arrayable point source loudspeaker.

### DETAILED DESCRIPTION

The present invention now will be described more fully hereinafter with reference to the accompanying drawings, in which some, but not all embodiments of the invention are exemplified.

Indeed, this invention may be embodied in many different forms and should not be construed as limited to the embodiments set forth herein; rather, these embodiments are provided so that this disclosure will satisfy applicable legal requirements. Like numbers refer to like elements throughout. It is to be understood that this invention is not limited to the particular methodology and protocols described, as such may vary. It is also to be understood that the terminology used herein is for the purpose of describing particular embodiments only and is not intended to limit the scope of the present invention.

Many modifications and other embodiments of the invention set forth herein will come to mind to one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

### Definitions

A “waveguide” refers to a structure that directionally guides sound waves presenting a resistive and modal acoustic load to the driver. In particular, waveguides are structures that have a mathematically derived shape (Geddes 1989), which allows a wavefront to propagate according to the wave equation, wherein the movement of air at the wavefront is normal to the wave front and parallel to the walls of the waveguide.

A “sound chamber”, a “wave-shaping sound chamber” or a “wave-shaping device” are partially-enclosed spaces that modify the shape or curvature of a wavefront according to arbitrary objectives.

A “phase plug” is an object occupying the void between the diaphragm surface and a smaller horn throat, which has acoustic passageways for the transmission of sound waves, forming an acoustical transformer between a diaphragm and the acoustic load of a horn, waveguide or sound chamber. The size of the openings of the acoustic passageways in relation to the size of the diaphragm defines the “compression ratio”. Conventional phase plugs are commonly found in MF and HF bandpasses, positioned between the compression driver diaphragm and the acoustic horn. They serve to equalize sound wave path lengths from the driver to the listener, to prevent cancellations and frequency response problems. The phase plug can be considered a further narrowing of the horn throat, becoming an extension of the horn to the surface of the diaphragm.

An “electro-acoustic transducer” is generally referred to as a speaker or driver. Drivers configured for lower frequency bands are low frequency drivers or LF drivers; those configured for intermediate frequency bands are mid-range drivers or MF drivers; and those configured for higher frequency bands are high frequency drivers or HF drivers. Conventionally, in the case of audio reproduction, LF refers to soundwaves having a frequency between about 40 to about 200 Hz. MF refers to soundwaves having a frequency between about 200 Hz to about 2000 Hz, while HF refers to the frequency range between about 2000 Hz to about 20 kHz.

An “enclosure” refers to a structure comprising any suitable material that provides a mounting location for a driver and fully or partially encloses a volume of air to be included in its acoustical behaviour.

A “cone and dome” diaphragm is a diaphragm which has a shape, when viewed in cross-section, a portion of which is a portion of a conical shape and another portion of which is dome shaped. A conical shape comprises straight lines which converge at a distance, while a dome shape has a degree of curvature and may be circular, ovoidal or elliptical.

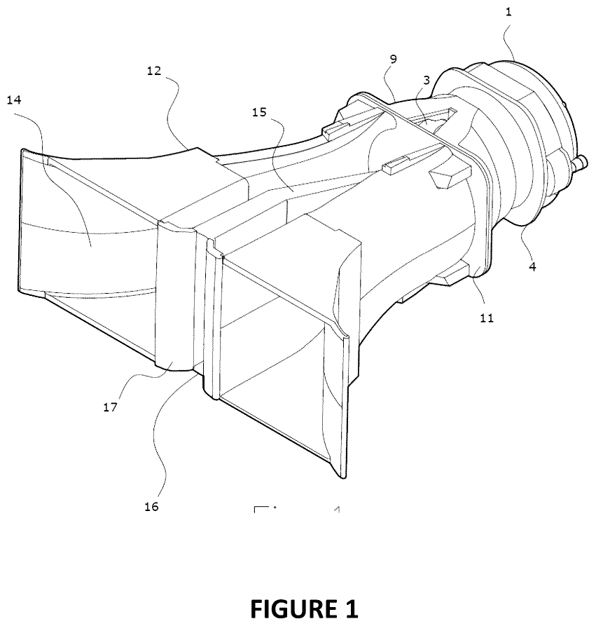

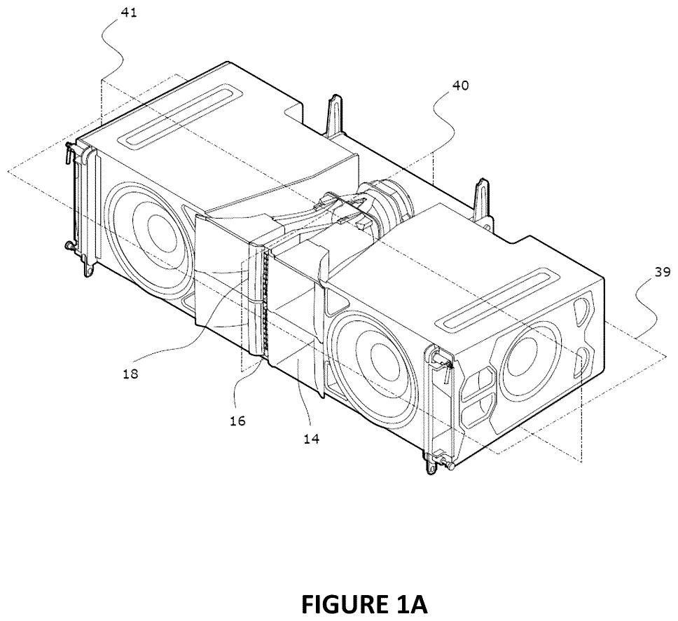

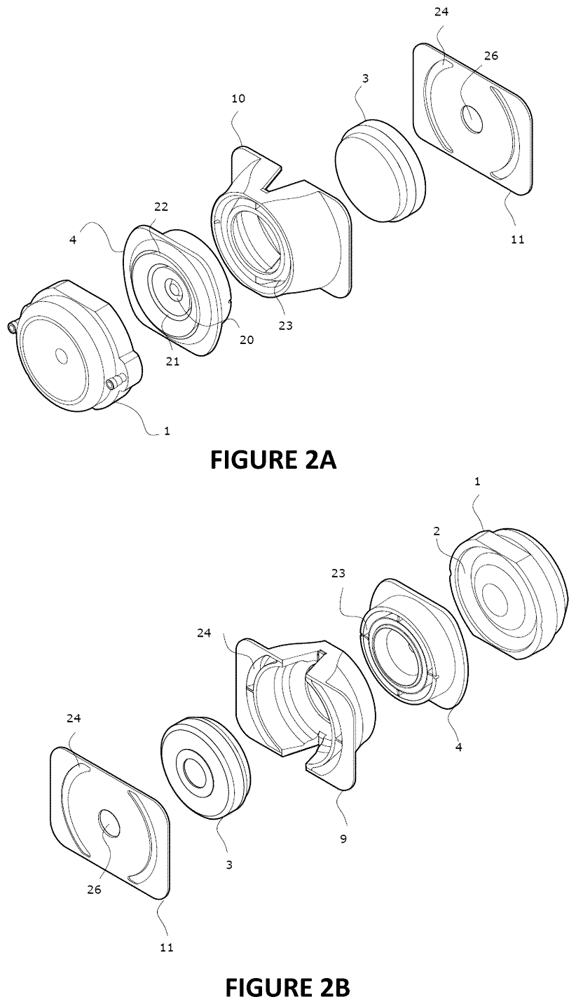

In this description, reference is made to Cartesian coordinate planes, wherein the y-axis is vertical, the x-axis is horizontal in a left-right direction, and the z-axis is horizontal in a front-back direction. Thus, with reference to FIG. 1A, the y-x plane 41 is vertical extending left to right; the y-z plane 40 is vertical extending front to back, and the x-z plane 39 is horizontal. The directional prepositions of vertical, horizontal, up, upwardly, down, downwardly, front, back, top, upper, bottom, lower, left, right and other such terms refer to the device as it is oriented and appears in the drawings and are used for convenience only; they are not intended to be limiting or to imply that the device has to be used or positioned in any particular orientation. Sound is emitted from the front of the apparatus. Conventional components of the invention are elements that are well-known in the prior art and will not be discussed in detail for this disclosure.

Disclosed is a loudspeaker assembly which includes a first driver 1 having a diaphragm 2 and a second driver 3, mounted in a co-axial concentric alignment, wherein the first driver 1 is a lower frequency driver than the second driver 3. In preferred embodiments, the first driver is an MF driver, while the second driver is an HF driver. The following description will refer to the first driver as an MF driver, and the second driver as a HF driver, with other components referred to in reference to the MF driver and HF driver. However, the described invention need not be limited to MF and HF drivers.

The MF driver 1 is physically mounted to a phase plug assembly 4, which is mounted to the transition duct 9. The HF driver 3 is mounted within capsule 8, which is disposed within the transition duct 9, and is affixed to an intermediary mounting plate 11. MF waveguides 12 and the HF sound chamber 15 are mounted to the opposing (front) side of the mounting plate 11. The HF sound chamber 15 is mounted to the HF waveguides 17.

The MF driver 1 and the HF driver 3 are disposed co-axially, in close proximity to each other, within MF transition duct 9 and phase plug outer housing 5. The phase plug assembly 4 is disposed in between the MF driver and the HF driver. These components not only provide mechanical mounting to the drivers 1 and 3, but also guide the sound wave generated by the MF diaphragm 2.

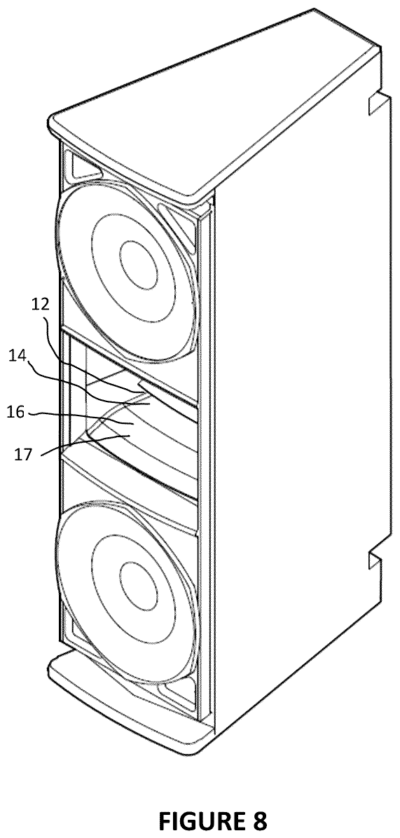

The HF-MF driver unit assembly may be combined with LF drivers in a 3-way loudspeaker system, as exemplified in FIG. 1A or alternatively in FIG. 8. The LF drivers are positioned adjacent the MF exits 14, which straddle the central HF exit 16, either horizontally or vertically.

The concentric and co-axial arrangement of MF driver 1 and HF driver 3 provides the MF driver acoustic path sufficient distance to reproduce lower-bandwidth audio within the MF range. The phase plug assembly 4 is configured to allow the device to extend its upper bandwidth. The phase plug assembly 4 is partially formed by a rear surface of a capsule 8 which has a convex curved shape, such as a semi-ovoid or semi-elliptical shape, and which encloses and mounts the HF driver 3. This arrangement will be described in greater detail below. The capsule rear surface has a concave portion which faces the first driver diaphragm 2.

In some embodiments, the HF driver 3 produces audio through an iso-phase circular exit 26 formed in mounting plate 11, which is acoustically coupled to HF sound chamber 15. The HF sound chamber 15 terminates in a near planar rectangular slot exit 16 through the HF sound chamber passageway 32, which is in turn coupled to the HF waveguide 17 and HF waveguide exit 18, which is situated directly between the parallel rectangular slots of the MF waveguide exit 14 resulting in a co-linear exit of the MF and HF waveguides. In this manner, it is possible to extend the acoustic pathlength of the MF section, which is necessary to reproduce lower-bandwidth audio.

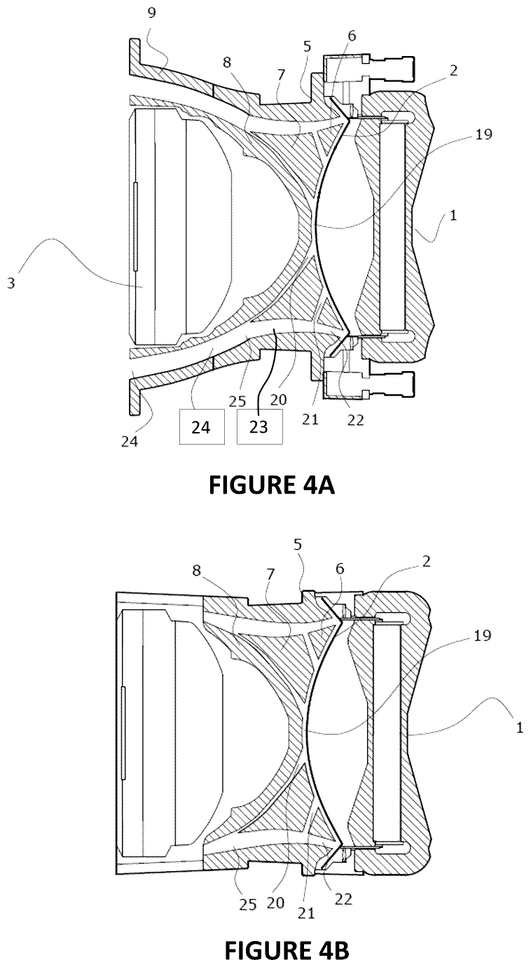

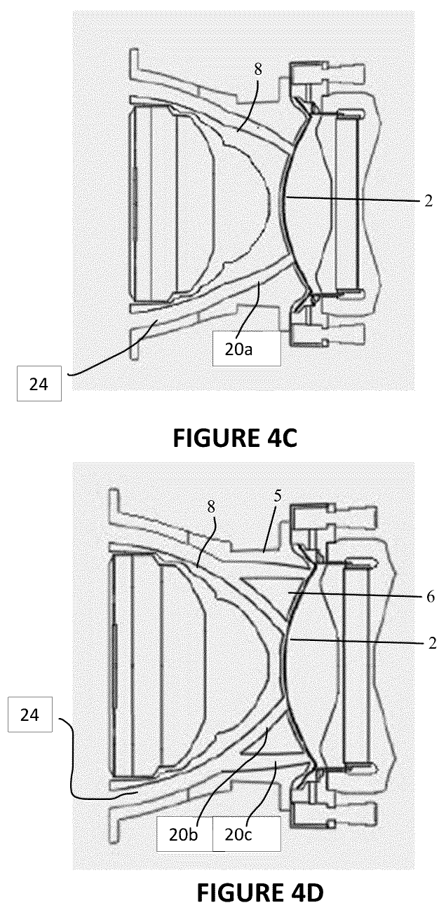

As seen in FIGS. 4A and 4B, the MF diaphragm 2 is acoustically coupled to the air cavity 19, which is the substantially uniform gap between the concave portion of the rear surface of the capsule 8 and the diaphragm 2. In some embodiments, the MF diaphragm may be any shape, but is preferably a cone and dome diaphragm.

In the embodiment shown in FIGS. 4A and 4B, the MF phase plug assembly 4 defines three concentric slots or passageways, inner slot 20, middle slot 21, and outer slot 22. These concentric slots 20, 21, 22 have a circular x-y vertical plane section shape, and are defined between the MF phase plug outer housing 5, a first ring 6, a second ring 7 and the HF capsule 8. The slots form three annular ring passageways. The outer slot 22 and middle slot 21 meet and combine in an annular passageway 23, which then meets and combines with the inner slot 20 at the point of MF phase plug convergence 25 to form curved passageway 24 which then is formed and extends around the HF capsule 8. The annular passageway 23 is acoustically coupled to the curved passageways 24 which are formed between the MF transition duct housing 9 and the HF capsule 8.

In alternative embodiments, shown in FIGS. 4C and 4D, the phase plug assembly 4 may define either a single slot 20a, or two converging slots 20b, 20c, leading from the MF diaphragm out towards the curved passageways 24. In the case of a single slot 20a, it is formed between the capsule 8 and the phase plug housing 5. In the case of two converging slots 20b, 20c, they are formed between capsule 8, ring 6 and housing 5.

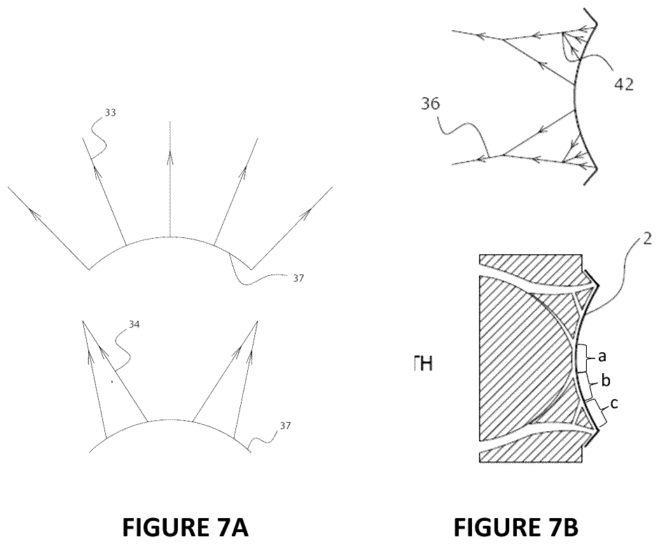

In preferred embodiments, where there are two or more slots, the inlets to such slots are spaced equidistant from each other, when viewed axisymetrically, as may be seen FIG. 7B, where distance a, b and c are the same. In other words, the distance between any two adjacent slot inlets is the same.

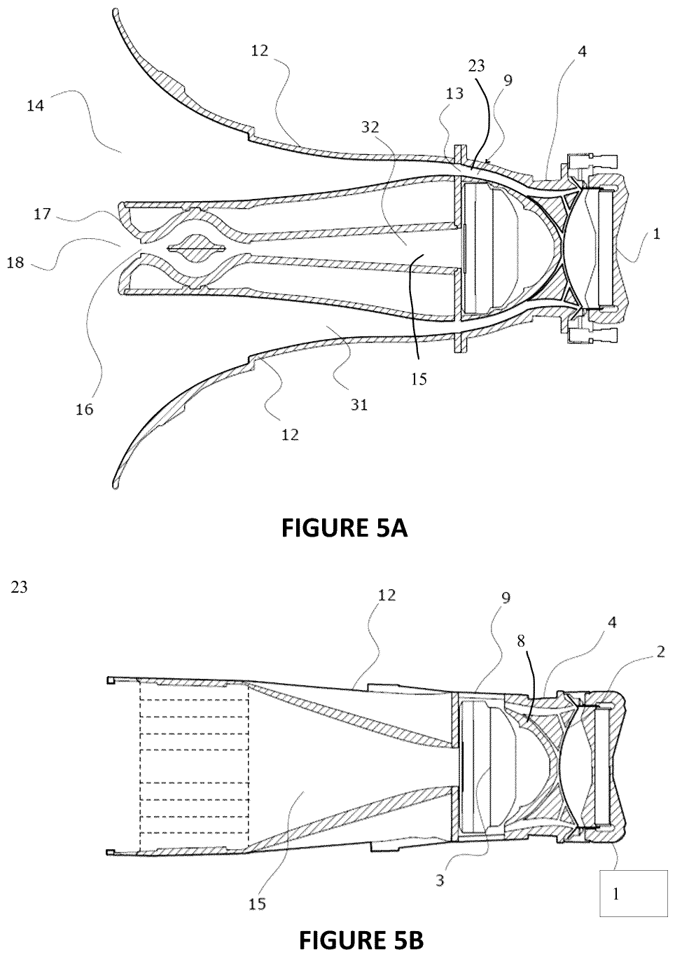

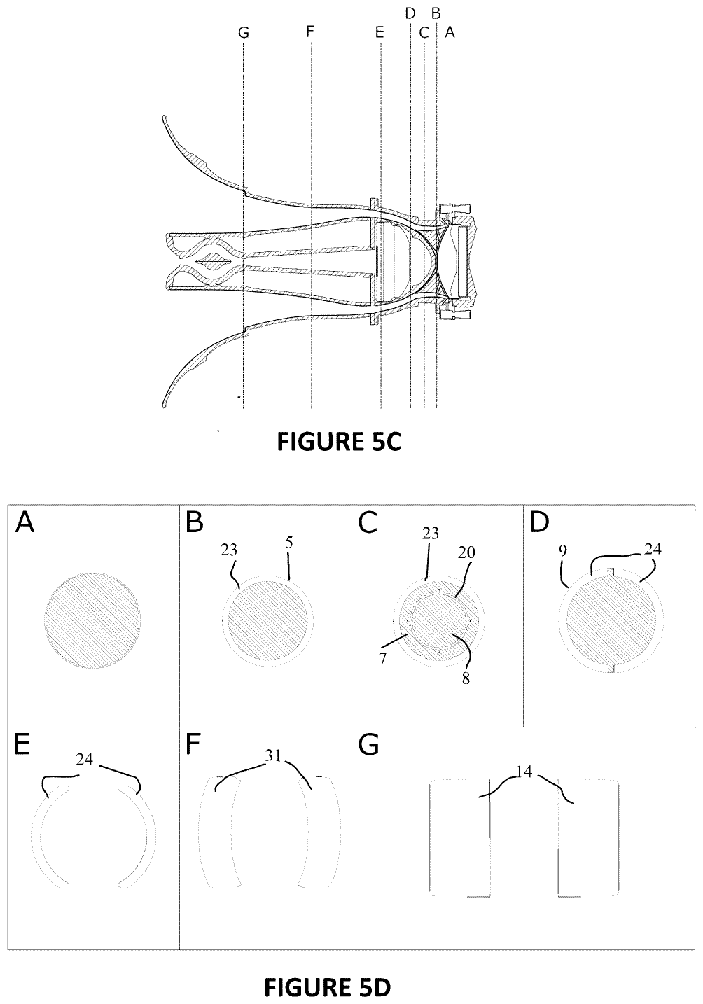

The geometry of the passageways 23 and 24 are defined between capsule 8 and duct 9 and provide an MF sound path that limits divergence and follows a rate of expansion associated with the overall design of the MF section. The capsule 8 is configured to mount the HF driver 3. Thus, with reference to FIGS. 5A, 5C, and 5D the curved passageways 24 are acoustically coupled to the MF waveguide inlets 13. The MF waveguide 12 provides two parallel acoustic paths that transform the curved passageways 24 at the MF waveguide inlets 13 through the MF waveguide passageway 31 to parallel rectangular slots at the MF waveguide exit 14. The entire assembly is mounted to front side of mounting plate 11.

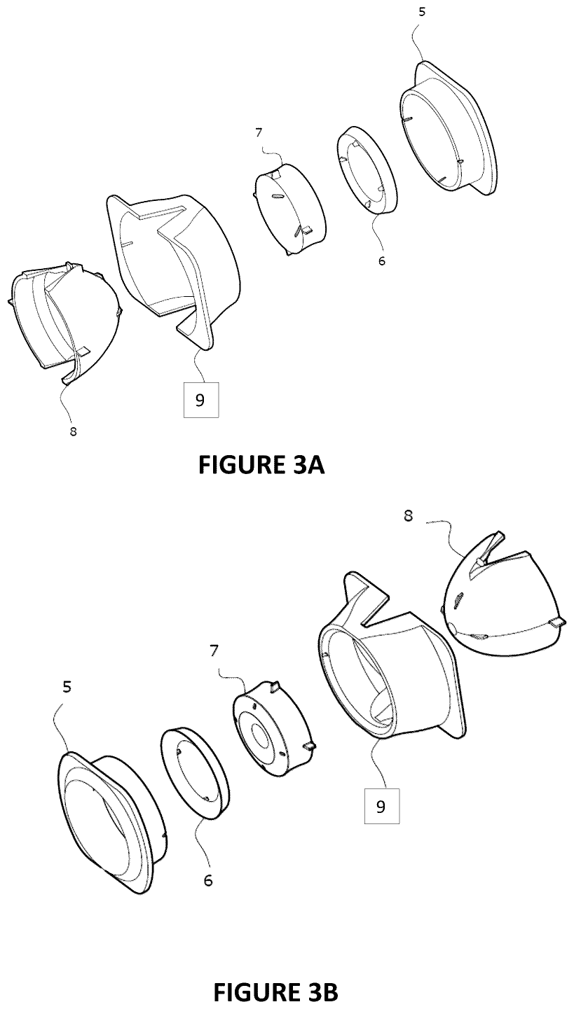

FIGS. 3a & 3b show exploded views of the MF phase plug assembly 4 and the MF transition duct assembly 9. The figures show an MF phase plug housing 5, an MF phase plug inner ring 6, an MF phase plug outer ring 7, an HF capsule 8 and an MF transition duct housing 9. The phase plug housing 5, rings 6, 7 and HF capsule 8 together define between them, the three annular slots 20, 21 and 22. The phase plug housing 5, HF capsule 8 and transition duct housing 9 together define the sound path as it transforms from the annular passageways 23 to curved passageways 24. It is noted that in FIGS. 3a & 3b, the HF capsule 8 is shown separated to better illustrate the passageway transition between the MF phase plug assembly 4 and the MF transition duct 9. In some embodiments, the HF capsule 8 is a single piece which is contained within both the MF phase plug assembly 4 and the MF transition duct assembly 9.

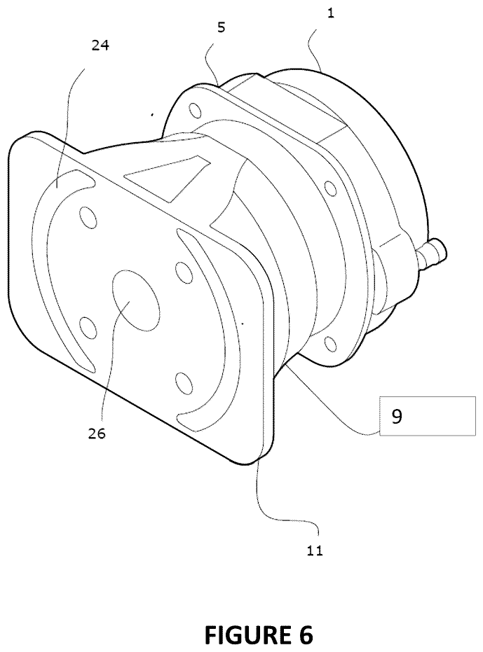

FIG. 6 is an isometric view of one embodiment of an assembled HF-MF driver unit, comprising the MF driver 1, MF phase plug assembly 4, MF transition duct assembly 9, HF driver 3 and mounting plate 11. The exits of this assembly formed by mounting plate 11 through the curved passageway 24 for mid frequency and the circular passageway 26 for high frequency are shown.

A schematic depiction of a convex diaphragm is displayed in FIG. 7a (top), which shows an axisymmetric drawing of the natural radiated path of sound waves 33 from a convex diaphragm 37. FIG. 7a (bottom) shows an example of a simple phase plug with two slots and equal pathlengths 34 fitted to a convex or dome shaped diaphragm 37, which naturally forms an annular summation, also shown.

The geometry or configuration of the phase plug assembly 4 can be adjusted to accommodate three or more slots, to raise the targeted high frequency limit, while maintaining annular summation, as shown in FIG. 7b (top), which illustrates schematically the airpaths of four slots, formed by three phase plug rings. Three outer slots converge at point 42, which then continues and merges with inner slot at point 43. Therefore, in accord with this annular summation, it is advantageous to position the HF driver 3 within its enclosure capsule 8 as close as possible to the MF diaphragm 2.

The HF capsule 8 also forms an integral piece of the phase plug assembly 4, to guide MF wavelengths to the point of convergence 25. In other words, the HF capsule 8 rear surface (facing the MF driver diaphragm 2) forms the interior wall for the MF wavefront passageway, while the capsule 8 front surface forms a cavity which houses the HF driver 3.

FIG. 4B is a vertical plane sectional diagram of the assembled HF-MF drive unit, showing the HF driver 3 placed in front of the MF driver 1. As a result, the MF driver's diaphragm 2 may be a solid body, increasing the radiating surface area and further allows a greater length for the MF passageways and waveguide. This configuration also allows the inlets to both the MF waveguide 12 and the HF sound chamber 15 to be terminated at the same distance. Furthermore, the use of the HF capsule 8 as both the inner wall of the annular passageway 23 and the curved passageway 24, as well as forming the air cavity which houses the HF driver 3, allows for efficient use of materials and space.

FIGS. 4A and 4B are sectional diagrams of the MF diaphragm 2 and the phase plug assembly 4. In some embodiments, slots 20, 21 & 22 have a combined cross-sectional area such that the compression ratio of the total surface area of the diaphragm 2 to the total slot cross-sectional area is about 7:1 (diaphragm to open slot area). The compression ratio preferably matches the impedance of the diaphragm to the horn throat. Higher ratios may be better in reproducing higher frequencies but can have negative impact on output and coherence.

In some embodiments, the slot inlets are configured such that the maximum distance between any two points on the MF diaphragm 2 which face a slot inlet does not exceed ¼ of the wavelength of the highest intended operating frequency, which may be between about 2 kHz to about 6 kHz. Thus, in some embodiments, this maximum distance may not exceed about 5.7 cm, about 4 cm, about 3 cm, or about 2.5 cm. The distances between points on the diaphragm 2 which face a slot inlet are shown as a, b, c in FIG. 7B. Furthermore, in preferred embodiments, the inlets to slots 20, 21 and 22 are placed equidistantly across the face of the phase plug, when viewed axisymmetrically. In other words, distances a, b and c are the same.

The upper efficient bandwidth limit of any phase plug is approximately 2× (speed of sound/width between slots) Extending the upper frequency limit can be accomplished principally by narrowing the width of the space between slot openings. In preferred embodiments, the face of the phase plug which faces the diaphragm 2 matches the curvature of the diaphragm such that the gap between the phase plug and the diaphragm 2 is constant. In other words, the gap between the rear facing surface of the capsule and the diaphragm and the gap between a rear facing surface of rings 6, 7 and the diaphragm are the same and uniform.

In loudspeaker design, the geometry of waveguides and other wave shaping devices must be considered, since any discontinuity in a passageway such as inlets and outlets (or more broadly, surfaces not normal to the wavefront) produce reflections and diffraction. These destructive reflections are limited by keeping certain dimensions shorter than ¼ of the dimension of the wavelength of the highest intended operating frequency, such as the distance between the MF diaphragm and a slot inlet, or the distance between a slot inlet and the passageway convergence. Therefore, in preferred embodiments, slots 20, 21 & 22 have been designed taking into consideration the distance between the slots, as well as the length of the passageways from the origin of the slots at the diaphragm to the point of convergence 25.

FIGS. 4A and 5A are x-z horizontal plane sectional diagrams which show the slots 20, 21, 22 defined by the MF phase plug assembly 4 joining to form an air passage first as an annular passageway 23 and then shaped as a curved passageway 24 beginning at the point of convergence 25. The annular passageway 23 is defined between the phase plug housing 5 and the HF capsule 8. The point of convergence 25 is where the MF transition duct assembly 9 is acoustically coupled to the MF phase plug assembly 4. The MF transition duct assembly 9 transforms the passageway shape from annular 23 to the curved passageways 24. The curved passageway 24 is acoustically coupled to the MF waveguide inlets 13 and the HF sound chamber 15, which has an exit 16 coupled to the HF waveguide 17. The HF waveguide terminates in rectangular slots at the MF waveguide exit 14 and the HF waveguide exit 18. The two parallel MF rectangular exits 14 are spaced equidistant from the HF waveguide's rectangular exit 18, an arrangement which is considered co-linear, as the MF and HF sound waves exit these devices at equal phase.

The HF sound chamber's central rectangular slot exit 16 channels acoustic energy generated by the HF driver 3 and shaped by the HF sound chamber 15. The HF sound chamber 15 is a wave shaping device that transforms the circular planar wave front produced at the circular exit 26 of the HF driver 3 into a planar or slightly vertically curved cylindrically shaped wavefront. The HF sound chamber achieves this wave shape by creating a plurality of discrete passageways within that create differing path lengths. The resulting wavefront usually exits through a linear exit, generally quite narrow in width. The narrow exit of the HF sound chamber 16 is acoustically coupled to the entrance of the HF waveguide 17, which serves to control the horizontal output pattern of the HF section.

The HF waveguide 17 can be formed in the same manner as the HF sound chamber 15 or by any number of other materials, such as wooden surfaces or metal plates.

FIGS. 5C and 5D show a progression of vertical x-y plane cross-sectional diagrams of the air passageways as the shape progresses from the initial air cavity (A) to the annular passageway (B) and (C), to curved passageways (D, E, F) to rectangular slots (G) at the exit of the MF waveguide 14. The expansion of the size of these passageways generally follows a mathematical rate of expansion, such as constant, exponential or hypex. A main purpose of a waveguide is to act as an impedance transformer, from the dense material of the diaphragm to the less-dense air.

In an alternative embodiment, shown in FIG. 8, the HF-MF driver unit comprising a loudspeaker assembly having a phase plug assembly 4 as described herein, is deployed in an arrayable point source, which exhibits a constant, rather than variable curvature. Constant curvature devices are employed with wider patterns. This increases the coverage area of each individual element, but makes the variability of coverage within an array not possible due to loss of coherence. This is an alternative to variable coverage line arrays, as shown in FIG. 1A, which are preferred when the pattern that is output is narrow enough to have a minimal impact on the phase angle of the wavefront emitted by each element in the array.

### Interpretation

The forgoing description supplies specific details in order to provide a thorough understanding. Nevertheless, the skilled artisan would understand that the apparatuses, systems, and associated methods of using the apparatuses and systems can be implemented and used without employing these specific details. Indeed, the apparatuses, systems, and associated methods can be placed into practice by modifying the illustrated apparatus and associated methods and can be used in conjunction with any other apparatus and techniques conventionally used in the industry.

The corresponding structures, materials, acts, and equivalents of all means or steps plus function elements in the claims appended to this specification are intended to include any structure, material, or act for performing the function in combination with other claimed elements as specifically claimed.

References in the specification to “one embodiment”, “an embodiment”, etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such module, aspect, feature, structure, or characteristic with other embodiments, whether or not explicitly described. In other words, any module, element or feature may be combined with any other element or feature in different embodiments, unless there is an obvious or inherent incompatibility, or it is specifically excluded.

It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition or step being referred to is an optional (not required) feature of the invention.

The singular forms “a,” “an,” and “the” include the plural reference unless the context clearly dictates otherwise. The term “and/or” means any one of the items, any combination of the items, or all of the items with which this term is associated. The phrase “one or more” is readily understood by one of skill in the art, particularly when read in context of its usage.

The term “about” can refer to a variation of ±5%, ±10%, ±20%, or ±25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values and ranges proximate to the recited range that are equivalent in terms of the functionality of the composition, or the embodiment.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. A recited range includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc.

As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio.

### REFERENCES

The following references are representative of the level of skill and knowledge of a person skilled in the art of loudspeaker design, and are incorporated herein by reference, where permitted.
U.S. Pat. Nos. 6,343,133 and 6,581,719 (Adamson)
Geddes, Acoustic Waveguide Theory, J. Audio Eng. Soc.
Wente, E. et al. “A High-Efficiency Receiver for a Horn-Type Loudspeaker of Large Power Capacity [1928] (reprint)”. Journal of the Audio Engineering Society. 26: 139-144. (March 1978)

What is claimed is:

1. A loudspeaker assembly having a waveguide, comprising:
(a) a housing comprising an outer duct and a phase plug housing;
(b) a first driver comprising a diaphragm;
(c) a second driver coaxially disposed in front of the first driver diaphragm and comprising a capsule having a rear surface, wherein a curved passageway is formed around the capsule within a duct; and
(d) a phase plug disposed between the first driver diaphragm and the second driver, the phase plug positioned within the phase plug outer housing, and defining at least one slot having an inlet for providing air movement between the first driver diaphragm and the curved passageway;
wherein the rear surface of the capsule forms part of the phase plug, and a gap is defined betweens the first driver diaphragm and the rear surface of the capsule, and wherein the first driver is a lower frequency driver than the second driver.

2. The loudspeaker assembly of claim 1 wherein the first driver is an MF driver and the second driver is a HF driver.

3. The loudspeaker assembly of claim 2 wherein the phase plug comprises at least one ring, wherein a first slot is formed between the at least one ring and the phase plug outer housing, and a second slot is formed between the at least one ring and the rear surface of the capsule.

4. The loudspeaker assembly of claim 3, wherein the phase plug comprises first and second rings, wherein a first slot is formed is formed between first ring and the phase plug outer housing, a second slot is formed between the first and second rings, and a third slot is formed between the second ring and the rear surface of the capsule.

5. The loudspeaker assembly of claim 4, wherein phase plug comprises a plurality of x rings are disposed between the rear surface of the capsule and the first driver diaphragm and the phase plug outer housing, such that x+1 slots are formed.

6. The loudspeaker assembly of claim 3, wherein the gap between the first driver diaphragm and a rear facing surface of the at least one ring is uniform and the gap between the first driver diaphragm and the rear surface of the capsule is uniform and the same.

7. The loudspeaker assembly of claim 4, wherein the slot inlets are spaced such that the maximum distance between any two points on the first driver diaphragm which face a slot inlet does not exceed ¼ of the wavelength of the highest intended operating frequency.

8. The loudspeaker assembly of claim 4, wherein the slot inlets are spaced equidistant from each other, when viewed axisymetrically.

9. The loudspeaker assembly of claim 4, wherein the first slot and second slot merge to form an annular passageway, and the annular passageway merges with the third slot to form a curved passageway.

10. The loudspeaker assembly of 9, wherein the first slot and the second slot length from their inlet to their merge point are the same.

11. The loudspeaker assembly of any claim 4, wherein the compression ratio is about 7:1.
